(19) United States
(12) Patent Application Publication
(10) Pub. No.: US 2010/0201932 A1
(43) Pub. Date: Aug. 12, 2010

(54) LIQUID CRYSTAL DISPLAY DEVICE

(75) Inventors: Jun GOTOH, Mobara (JP); Miyo Ishii, Chiba (JP); Daisuke Sonoda, Chiba (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Displays, Ltd.

(21) Appl. No.: 12/700,768

(22) Filed: Feb. 5, 2010

(30) Foreign Application Priority Data
Feb. 9, 2009 (JP) 2009-027309

(51) Int. Cl. G02F 1/1343

(52) U.S. Cl. 349/141; 349/187

(57) ABSTRACT

An IPS liquid crystal display device having comb-teeth-shaped pixel electrodes which can prevent image retention while ensuring reliability of through hole portions and reliability of terminal area is provided. In an IPS liquid crystal display device having comb-teeth-shaped pixel electrodes, image retention occurs when rubbing is not applied to a gap defined between the comb-teeth-shaped electrodes. The pixel electrodes, through holes which supply a voltage to the pixel electrodes and a terminal area are formed of an ITO film. By setting a film thickness of only the ITO film for forming the pixel electrodes smaller than a film thickness of the ITO film formed at the through holes and a film thickness of the ITO film for forming the terminal area, it is possible to sufficiently apply rubbing to a gap between the comb-teeth-shaped electrodes which constitute the pixel electrodes.

### CLAIM OF PRIORITY

The present application claims priority from Japanese application serial No. 2009-27309, filed on Feb. 9, 2009, the content of which is hereby incorporated by reference into this application.

### BACKGROUND OF THE INVENTION

1. Field of the Invention

The present invention relates to a display device, and more particularly to a relatively small lateral-electric-field liquid crystal display device which possesses an excellent viewing angle characteristic.

2. Background Art

In a liquid crystal display device, a TFT substrate on which pixel electrodes, thin film transistors (TFT) and the like are formed in a matrix array and a counter substrate which faces the TFT substrate in an opposed manner and forms color filters and the like on portions thereof corresponding to the pixel electrodes formed on the TFT substrate are arranged. Further, liquid crystal is sandwiched between the TFT substrate and the counter substrate. An image is formed by controlling optical transmissivity of liquid crystal molecules for every pixel.

A viewing angle characteristic is important in the liquid crystal display device. Here, the viewing angle characteristic is a phenomenon where brightness is changed or chromaticity is changed between a case where a screen is viewed from a front side and a case where the screen is viewed in the oblique direction. An IPS (In Plane Switching) liquid crystal display device which operates liquid crystal molecules using an electric field generated in the horizontal direction possesses an excellent viewing angle characteristic.

In the liquid crystal display device, a pixel region is formed of an ITO (Indium Tin Oxide) film which constitutes a transparent electrode. When a thickness of the ITO film becomes large, there may be a case where the display device cannot perform a completely white display due to a spectral characteristic of the ITO film. Further, for example, incase of a liquid crystal display device which uses STN (Super Twisted Nematic) liquid crystal and does not use TFTs as switching elements, scanning electrodes arranged in a stripe shape are formed on one substrate, video signal electrodes arranged in a stripe shape are formed on another substrate, and pixels are formed at intersections of the scanning electrodes and the video signal electrodes. In this case, when a thickness of an ITO film which constitutes the scanning electrodes or the video signal electrodes is large, these electrodes can be observed from the outside so that image quality is deteriorated.

On the other hand, ITO is metal oxide and is chemically stable and hence, ITO is used as a material for forming terminal electrodes at a terminal area. An ITO film which is used as a terminal electrode plays a role of protecting the terminal area and hence, the ITO film is required to have a predetermined thickness. However, when the thickness of the ITO film which is used as the electrode in a display region becomes large, the above-mentioned drawbacks arise.

JP-A-11-64870 (patent document 1) discloses an STN liquid crystal display device having the following constitution to make a film thickness of an ITO film at a terminal area large and to make the thickness of the ITO film in a display region small. That is, the manufacture of the STN liquid crystal display device includes a photolithography step of patterning an ITO film, and a photolithography step of decreasing a thickness of the ITO film in a display region. Due to such a constitution, the thickness of the ITO film in the display region can be set smaller than the film thickness of the ITO film at the terminal area.

### SUMMARY OF THE INVENTION

A TFT liquid crystal display device which uses a TFT as a switching element in each pixel has the structure and the manner of operation completely different from those of the STN liquid crystal display device. Further, also in the TFT liquid crystal display device, the usual TN liquid crystal display device, the VA liquid crystal display device and the IPS liquid crystal display device completely differ from each other with respect to the structure and the manner of operation.

In the IPS liquid crystal display device, a comb-teeth-shaped pixel electrode or a counter electrode is formed of an ITO film for every pixel. When a size of the pixel becomes small along with the miniaturization of the liquid crystal display device, a width, a pitch and the like of the pixel electrodes or the counter electrodes also become small. In the IPS liquid crystal display device, to impart initial alignment to liquid crystal, an alignment film is formed on pixel electrodes and the like, and rubbing is applied to the alignment film in a specified direction thus determining the initial alignment direction of liquid crystal.

In this case, when a thickness of the ITO film is large, for example, there arises a phenomenon that rubbing is not sufficiently applied to an alignment film arranged in a valley between the comb-teeth-shaped electrode and the comb-teeth-shaped electrode. When rubbing is not sufficiently applied to the alignment film, there arises a phenomenon that liquid crystal molecules do not return to the initial alignment direction after being twisted or the like due to an electric field. This phenomenon appears, on a screen of the liquid crystal display device, as a phenomenon in which a screen of a previous frame remains, that is, image retention phenomenon. This image retention extremely deteriorates image quality.

It is an object of the present invention to provide an IPS liquid crystal display device which can suppress such an image retention phenomenon.

The present invention has been made to overcome the above-mentioned drawbacks, and the specific constitutions of the present invention are as follows.

(1) According to one aspect of the present invention, there is provided a liquid crystal display device having a liquid crystal display panel, the liquid crystal display panel which includes: a TFT substrate where pixels each of which includes a comb-teeth-shaped first electrode, a planar second electrode and a TFT are formed in a matrix array so as to form a display region, and a terminal area which includes terminal electrodes is formed outside the display region; a counter substrate on which color filters are formed; and a liquid crystal layer which is sandwiched between the TFT substrate and the counter substrate, wherein the first electrode is arranged above the second electrode with an insulation film sandwiched therebetween, the first electrode and the second electrode are formed of an ITO film, the first electrode is connected with the TFT via the ITO film formed in a through hole, and the terminal electrodes are formed of the ITO film, and a thickness of the ITO film for forming the first electrode is smaller than a thickness of the ITO film formed in the through hole and a thickness of the ITO film formed on the terminal area.

(2) In the liquid crystal display device having the above-mentioned constitution (1), the first electrode is a pixel electrode, and the second electrode is a counter electrode.

(3) In the liquid crystal display device having the above-mentioned constitution (1), the first electrode is a counter electrode, and the second electrode is a pixel electrode.

(4) In the liquid crystal display device having any one of the above-mentioned constitutions (1) to (3), a thickness of the ITO film for forming the first electrode is half or less of a thickness of the ITO film formed in the through hole and also is half or less of a thickness of the ITO film which constitutes the terminal electrodes.

(5) According to another aspect of the present invention, there is provided a liquid crystal display device having a liquid crystal display panel, the liquid crystal display panel which includes: a TFT substrate where pixels each of which includes a comb-teeth-shaped pixel electrode and a TFT are formed in a matrix array so as to form a display region, and a terminal area which includes terminal electrodes is formed outside the display region; a counter substrate on which color filters are formed; and a liquid crystal layer which is sandwiched between the TFT substrate and the counter substrate, wherein the pixel electrode is formed of an ITO film, the first electrode is connected with the TFT via the ITO film formed in a through hole, and the terminal electrodes are formed of the ITO film, and a thickness of the ITO film for forming the pixel electrode is smaller than a thickness of the ITO film formed in the through hole and a thickness of the ITO film formed on the terminal area.

(6) In the liquid crystal display device having the above-mentioned constitution (5), a thickness of the ITO film for forming the pixel electrode is half or less of a thickness of the ITO film formed in the through hole and also is half or less of a thickness of the ITO film which constitutes the terminal electrodes.

(7) According to still another aspect of the present invention, there is provided a manufacturing method of a liquid crystal display device having a liquid crystal display panel, the liquid crystal display panel which includes: a TFT substrate where pixels each of which includes a comb-teeth-shaped first electrode, a planar second electrode and a TFT are formed in a matrix array so as to form a display region, and the first electrode being arranged above the second electrode with an insulation film sandwiched therebetween, the first electrode being formed of an ITO film and the first electrode and the TFT being connected with each other via an ITO film formed in a through hole, and a terminal area which includes terminal electrodes formed of an ITO film is formed outside the display region; a counter substrate on which color filters are formed; and a liquid crystal layer which is sandwiched between the TFT substrate and the counter substrate, the manufacturing method of a liquid crystal display device including the steps of: simultaneously forming the ITO film for forming the first electrodes, the ITO film formed at the through holes and the ITO film for forming the terminal electrodes; applying half exposure to portions of a photo resist corresponding to the pixel electrodes in performing patterning by applying the photo resist on the ITO films which are formed simultaneously and by exposing the photo resist; developing the photo resist and etching the ITO film using the photo resist; etching back the photo resist so as to remove the photo resist formed on the pixel electrodes and leaving the photo resist formed at the through holes and at the terminal electrodes, etching the pixel electrodes so as to make the ITO film for forming the pixel electrodes small; and removing the photo resist formed at the through holes and at the terminal electrodes.

(8) In the manufacturing method of the liquid crystal display device having the above-mentioned constitution (7), the photo resist is etched back by an oxygen asher.

According to the present invention, the film thickness of the ITO film which constitutes the pixel electrodes is set smaller than the film thickness of the ITO film formed at the through holes and the film thickness of the ITO film formed at the terminal areas. Accordingly, it is possible to acquire a liquid crystal display device which can sufficiently perform rubbing in the vicinity of the pixel electrodes thus having no image retention while ensuring the reliability of the through hole portions and the reliability of the terminal areas.

Further, according to the present invention, in the photolithography step, by applying the half exposure to portions where the pixel electrodes are formed and the full exposure to other portions, it is possible to form the thin ITO film at the pixel electrodes and the thick ITO film at the through holes and terminal areas without increasing the number of photolithography steps.

### BRIEF DESCRIPTION OF THE DRAWINGS

FIG. 1 is a cross-sectional view of a liquid crystal display device to which the present invention is applied;

FIG. 2 is a plan view of a pixel electrode;

FIG. 3 is a schematic cross-sectional view of a rubbing step;

FIG. 4A to FIG. 4D are views showing a former half of manufacturing steps which can realize the constitution of the present invention; and

FIG. 5A to FIG. 5C are views showing a latter half of the manufacturing steps which can realize the constitution of the present invention.

### DESCRIPTION OF THE PREFERRED EMBODIMENT

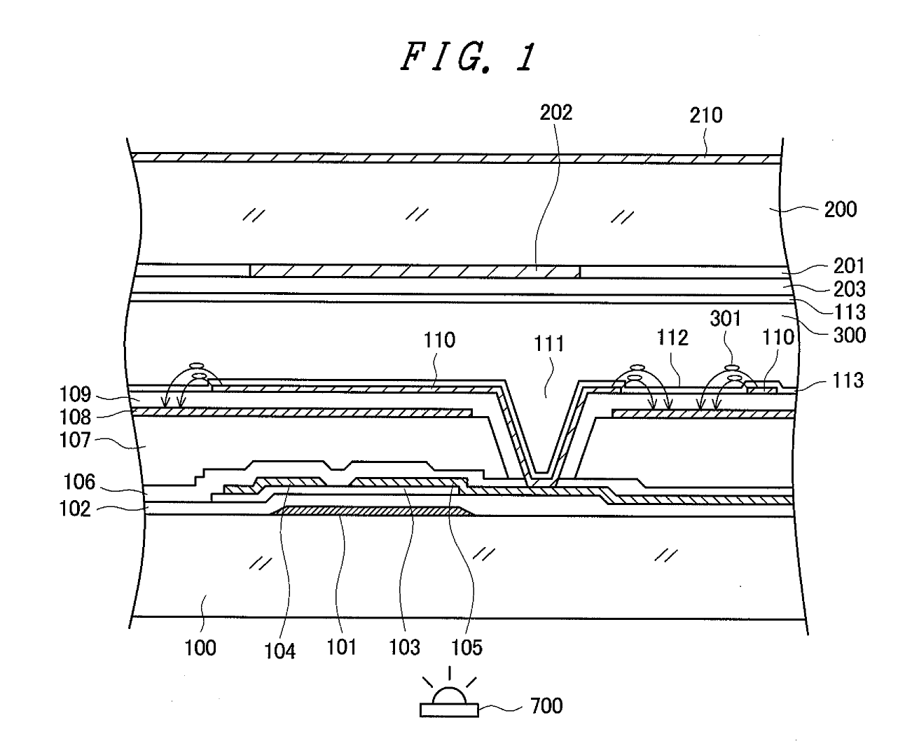

FIG. 1 is a cross-sectional view of an IPS liquid crystal display device to which the present invention is applied. In FIG. 1, gate electrodes 101 are formed on a TFT substrate 100 made of glass. The gate electrodes 101 are formed on the same layer as scanning lines. The gate electrode 101 is formed by stacking an MoCr alloy layer on an AlNd alloy layer.

A gate insulation film 102 made of SiN is formed so as to cover the gate electrodes 101. A semiconductor layer 103 which is formed of an a−Si film is formed over the gate insulation film 102 at a position where the semiconductor layer 103 faces the gate electrode 101 in an opposed manner. The a−Si film is formed by a plasma CVD method. The a−Si film forms a channel portion of a TFT, and a source electrode 104 and a drain electrode 105 are formed on the a−Si film in a state that the channel portion is sandwiched between the source electrode 104 and the drain electrode 105. Here, an n+Si layer not shown in the drawing is formed between the a−Si film and the source electrode 104 and between the a−Si film and the drain electrode 105. The n+Si layer is provided for establishing an ohmic contact between the semiconductor layer and the source electrode 104 and between the semiconductor layer and the drain electrode 105.

A video signal line functions also as the source electrode 104, and the drain electrode 105 is connected to a pixel electrode 110. The source electrode 104 and the drain electrode 105 are formed on the same layer simultaneously. In this embodiment, the source electrode 104 or the drain electrode 105 is made of an MoCr alloy. When it is necessary to lower electric resistance of the source electrode 104 or the drain electrode 105, for example, the source electrode 104 or the drain electrode 105 adopts the electrode structure where an AlNd alloy layer is sandwiched between MoCr alloy layers.

An inorganic passivation film 106 made of SiN is formed so as to cover the TFTs. The inorganic passivation film 106 is provided for protecting, particularly, the channel portions of the TFTs from impurities. An organic passivation film 107 is formed on the inorganic passivation film 106. Besides a role of protecting the TFTs, the organic passivation film 107 also has a surface leveling function so that the organic passivation film 107 has a large thickness. That is, the thickness of the organic passivation film 107 is set to 1 μm to 4 μm.

The organic passivation film 107 is formed using a photosensitive acrylic resin, a silicon resin, a polyimide resin or the like as a material. It is necessary to form through holes in the organic passivation film 107 at positions where the pixel electrodes 110 and the drain electrodes 105 are connected with each other. Since the organic passivation film 107 has photosensitivity, it is possible to form the through holes by exposing and developing the organic passivation film 107 per se without using a photoresist.

A counter electrode 108 is formed on the organic passivation film 107. The counter electrode 108 is formed such that a transparent conductive film made of ITO (Indium Tin Oxide) is formed on the whole display region by sputtering. That is, the counter electrode 108 is formed in a planar shape. After forming the counter electrode 108 on the whole surface of the display region by sputtering, the counter electrode 108 is removed by etching only at through hole portions where the pixel electrode 110 and the drain electrode 105 are made conductive with each other.

An upper insulation film 109 made of SiN is formed so as to cover the counter electrode 108. After upper electrodes are formed, the through holes are formed in the upper electrodes by etching. Using the upper insulation film 109 as a photo resist, the through holes 111 are formed in the inorganic passivation film 106 by etching. Thereafter, an ITO film for forming the pixel electrodes 110 is formed by sputtering so as to cover the upper insulation film 109 and the through holes 111. By patterning the ITO film which is formed by sputtering, the pixel electrodes 110 are formed. The ITO film for forming the pixel electrodes 110 is also adhered to the through holes 111. The drain electrode 105 which extends from the TFT and the pixel electrode 110 are made conductive with each other via the through hole 111, and a video signal is supplied to the pixel electrode 110.

The pixel electrode 110 is formed of comb-teeth-shaped electrodes. A slit 112 is formed between comb-tooth-shaped electrodes. A reference voltage is applied to the counter electrode 108 and a voltage in response to a video signal is applied to the pixel electrode 110. When the voltage is applied to the pixel electrode 110, as shown in FIG. 1, lines of electric force are generated and liquid crystal molecules 301 are rotated in the direction of the lines of electric force thus controlling transmission of light from a backlight 700. By controlling the transmission of light from the backlight 700 for every pixel, an image is formed. Here, an alignment film 113 for aligning the liquid crystal molecules 301 is formed on the pixel electrodes 110.

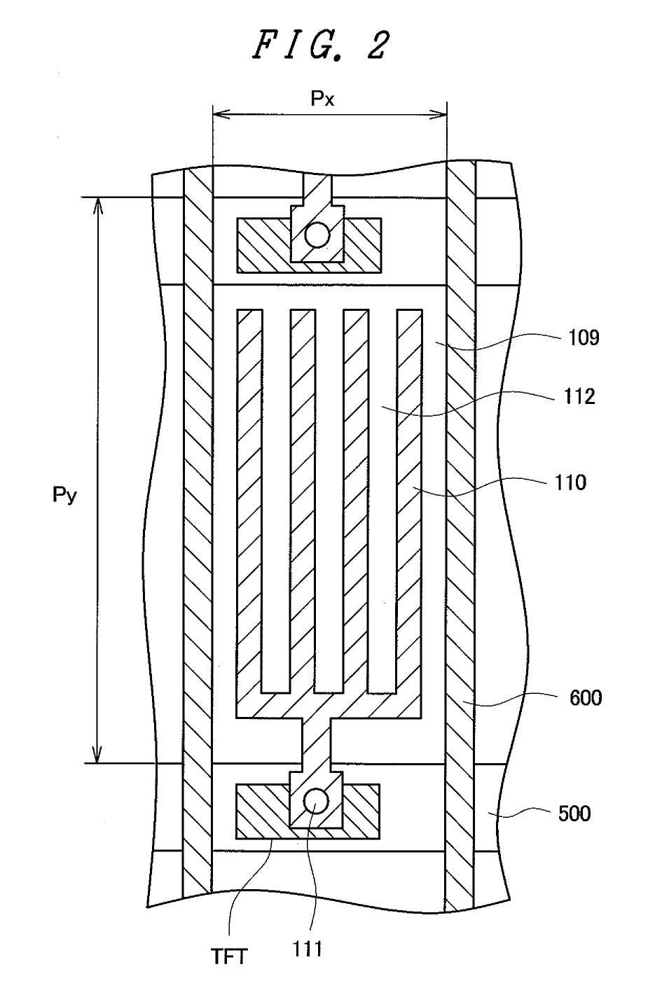

FIG. 2 is a plan view showing the display area of the liquid crystal display device explained heretofore. In FIG. 2, the pixel is formed in a region surrounded by scanning lines 500 and video signal lines 600. A lateral pitch px of the pixel is approximately 30 μm, and a longitudinal pitch py of the pixel is approximately 90 μm. Although the TFT which has been explained in conjunction with FIG. 1 is formed on the scanning line 500, the detailed constitution of the TFT is omitted from FIG. 2.

In the display area shown in FIG. 2, the comb-teeth-shaped pixel electrode made of ITO is formed. The pixel electrode 110 is formed on the upper insulation film 109. Although the counter electrode is formed below the upper insulation film 109 in a planar shape, the counter electrode is omitted from FIG. 2. The pixel electrode 110 is connected to the drain electrode of the TFT via the through hole 111.

A size of the pixel is small and hence, a width w of the comb-tooth-shaped electrode and a distance g between the comb-teeth-shaped electrodes are also small. For example, the width w of the comb-tooth-shaped electrode is approximately 4 μm, and the distance g between the comb-tooth-shaped electrodes is approximately 4 μm. The distance between the comb-tooth-shaped electrodes is small in this manner and hence, there arises a drawback that rubbing is not applied to a region defined between the comb-tooth-shaped electrodes sufficiently as described later.

In the examples shown in FIG. 1 and FIG. 2, the planar-shaped counter electrode 108 is arranged on the organic passivation film 107, and the comb-teeth-shaped electrodes 110 are arranged on the upper insulation film 109. However, as an opposite case, a planar-shaped pixel electrode 110 may be arranged on the organic passivation film 107, and a comb-teeth-shaped counter electrode 108 may be arranged on the upper insulation film 109. Here, in the explanation made hereinafter, the comb-teeth-shaped electrode on an upper side constitutes the pixel electrode 110, and the planar matted electrode on a lower side constitutes the counter electrode 108.

In FIG. 1, a counter substrate 200 is arranged on the TFT substrate 100 with the liquid crystal layer 300 sandwiched therebetween. Color filters 201 are formed on an inner side of the counter substrate 200. With respect to the color filters 201, red, green and blue color filters 201 are formed in each pixel thus forming a color image. A black matrix 202 is formed between the color filters 201 thus enhancing contrast of the image. Here, the black matrix 202 also functions as a light blocking film for the TFT thus preventing a photo current from flowing into the TFT.

An overcoat film 203 is formed so as to cover the color filters 201 and the black matrix 202. Surfaces of the color filters 201 and the black matrix 202 are uneven and hence, the overcoat film 203 is provided for surface leveling. The alignment film 113 which determines the initial alignment of liquid crystal is formed on the overcoat film 203. In FIG. 2, the liquid crystal display device is the IPS liquid crystal display device and hence, the counter electrode 108 is formed on the TFT substrate 100 side but is not formed on the counter substrate 200 side.

As shown in FIG. 1, in the IPS liquid crystal display device, a conductive film is not formed on an inner side of the counter substrate 200. Accordingly, a potential of the counter substrate 200 becomes unstable. Further, electromagnetic noises intrude into the liquid crystal layer 300 from the outside and influence the image. To overcome such a drawback, a surface conductive film 210 is formed on an outer side of the counter substrate 200. The surface conductive film 210 is a transparent conductive film which is formed by sputtering ITO.

As shown in FIG. 1, the pixel electrodes 110, the TFTs and the like are formed on the TFT substrate 100 in a matrix array, the color filters and the like are formed on the counter substrate 200, and liquid crystal is sandwiched between the TFT substrate 100 and the counter substrate 200. A panel having such a constitution is referred to as a liquid crystal display panel. Further, in FIG. 1, a backlight 700 is arranged on a back surface of the TFT substrate 100. The liquid crystal display device is constituted by assembling the backlight to the liquid crystal display panel.

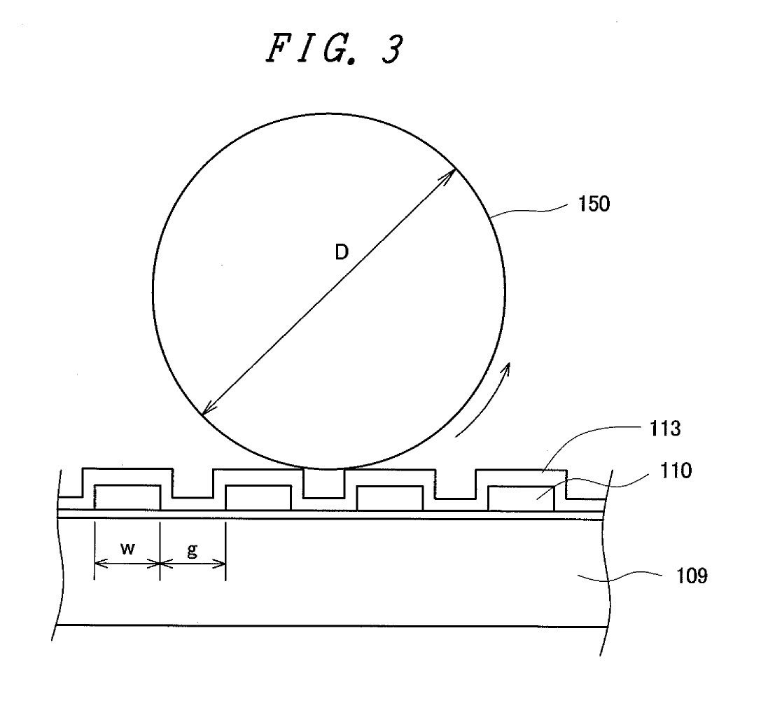

FIG. 3 is a schematic cross-sectional view showing a drawback which the IPS liquid crystal display device explained in conjunction with FIG. 1 and FIG. 2 has. In FIG. 3, the pixel electrode 110 is formed on the upper insulation film 109 which is formed on the TFT substrate 100, and the alignment film 113 is formed on the pixel electrode 110. A rubbing fiber 150 having a substantially circular cross section is arranged on the alignment film 113. The fiber 150 of a rubbing cloth moves in the direction indicated by an arrow and rubs a surface of the alignment film 113, for example.

Rubbing is an operation where a cloth-like article rubs the alignment film 113 formed on the TFT substrate 100 or on the counter substrate 200. The fiber 150 which constitutes the cloth is shown in FIG. 3. That is, the alignment film 113 is rubbed by each fiber 150.

As shown in FIG. 3, the pixel electrode 110 is small and hence, both the width of the comb-tooth-shaped electrode which constitutes the pixel electrode 110 and the distance between the comb-tooth-shaped electrodes are also extremely small. For example, the width w of the comb-tooth-shaped electrode is 4 μm, and the distance g between the comb-tooth-shaped electrodes is 4 μm. To the contrary, a diameter of the fiber 150 of the rubbing cloth is approximately 20 μm.

Accordingly, as shown in FIG. 3, the fiber 150 of the rubbing cloth cannot intrude into a gap defined between the comb-tooth-shaped electrodes. As a result, it is impossible to apply the rubbing treatment to the gap between the comb-tooth-shaped electrodes so that liquid crystal present in such a portion is not aligned sufficiently.

When a voltage is applied to the pixel electrode 110 in an initial alignment state, liquid crystal molecules are twisted in the direction of an electric field, while when the application of the voltage to the pixel electrode 110 is stopped, liquid crystal molecules return to the initial alignment state. In such a case, when the alignment film 113 is not rubbed sufficiently, even after the application of voltage to the pixel electrode 110 is stopped, liquid crystal molecules hardly return to the initial alignment direction. Accordingly, an image displayed on a preceding frame remains and this phenomenon is observed as image retention. The generation of the image retention remarkably deteriorates image quality and hence, it is necessary to prevent the generation of the image retention.

As has been explained heretofore, the generation of the image retention is caused by the insufficient rubbing of the alignment film 113 disposed between the comb-tooth-shaped electrodes. This is because that the fiber 150 of the rubbing cloth cannot intrude into the gap defined between the comb-tooth-shaped electrodes. To allow the fiber 150 of the rubbing cloth to sufficiently intrude into the gap between the comb-tooth-shaped electrodes, it is considered effective to increase the distance between the comb-tooth-shaped electrodes or to decrease a film thickness of the comb-tooth-shaped electrode.

For ensuring predetermined resolution, it is necessary to decrease a size of the pixel and hence, the reduction of a size of the pixel electrode 110 is limited. Accordingly, it is difficult to increase the distance between the comb-teeth-shaped electrodes. On the other hand, the role of the pixel electrode 110 is to generate an electric field in a liquid crystal layer and hence, there arises no problem even when the resistance of the pixel electrode 110 is increased.

Accordingly, from a viewpoint of the electric resistance, there is no problem in decreasing a film thickness of the ITO film which forms the pixel electrode 110. Although the film thickness of the ITO film which forms the current pixel electrode 110 is approximately 77 μm, even when the film thickness of the ITO film is decreased to approximately 50 μm or less or is further decreased to approximately 30 μm or less or approximately 10 μm or less, it is possible to operate the liquid crystal display device without causing any problem.

However, with respect to the ITO film at the through hole portions 111 and the ITO film used for forming the terminal electrodes 400 of the terminal area 401 which are formed simultaneously with the formation of the ITO film at the pixel electrodes 110, it is necessary to maintain the film thickness of the ITO film at the through hole portions 111 and the film thickness of the ITO film used in the terminal electrodes 400 to approximately 77 μm. The through hole portion 111 has an uneven surface. Accordingly, to prevent the conduction failure attributed to a broken step in the through hole portion 111, it is necessary for the ITO film to ensure a predetermined thickness. Further, when the ITO film cannot ensure a predetermined film thickness at the terminal electrode 400 in the terminal area 401, the ITO film cannot maintain a role of a protective film.

In this manner, it is necessary to form the thin ITO film at the pixel electrode 110 and the thick ITO film at the through hole portions 111 and at the terminal area 401 while forming these ITO films simultaneously. The ITO film may be formed separately among the pixel electrode 110, the through hole portion 111 and the terminal area 401. In this case, however, the number of photolithography steps is increased and this becomes one of factors which push up a manufacturing cost.

By performing the process explained hereinafter, the present invention can form the thin ITO film at the pixel electrodes 110 and the thick ITO film at the through hole portions 111 and the terminal area 401 without increasing the number of photolithography steps. A process which can provide the above-mentioned structure is explained by the embodiments described hereinafter.

### Embodiment 1

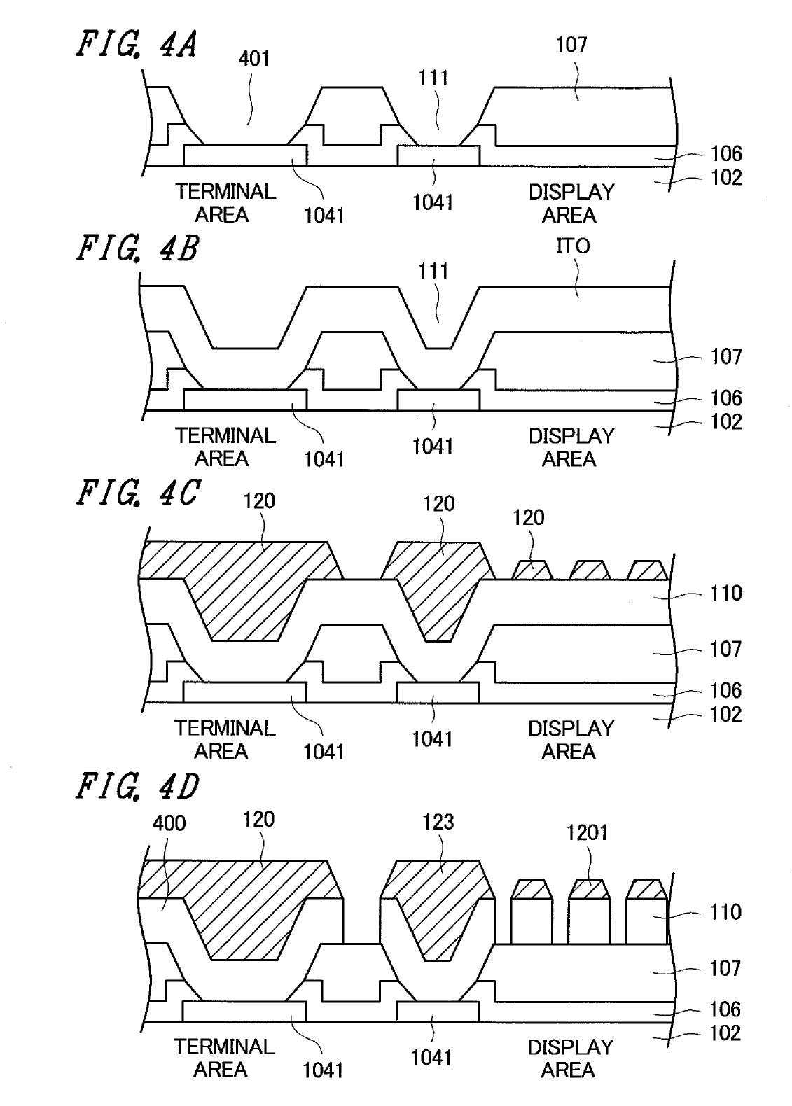

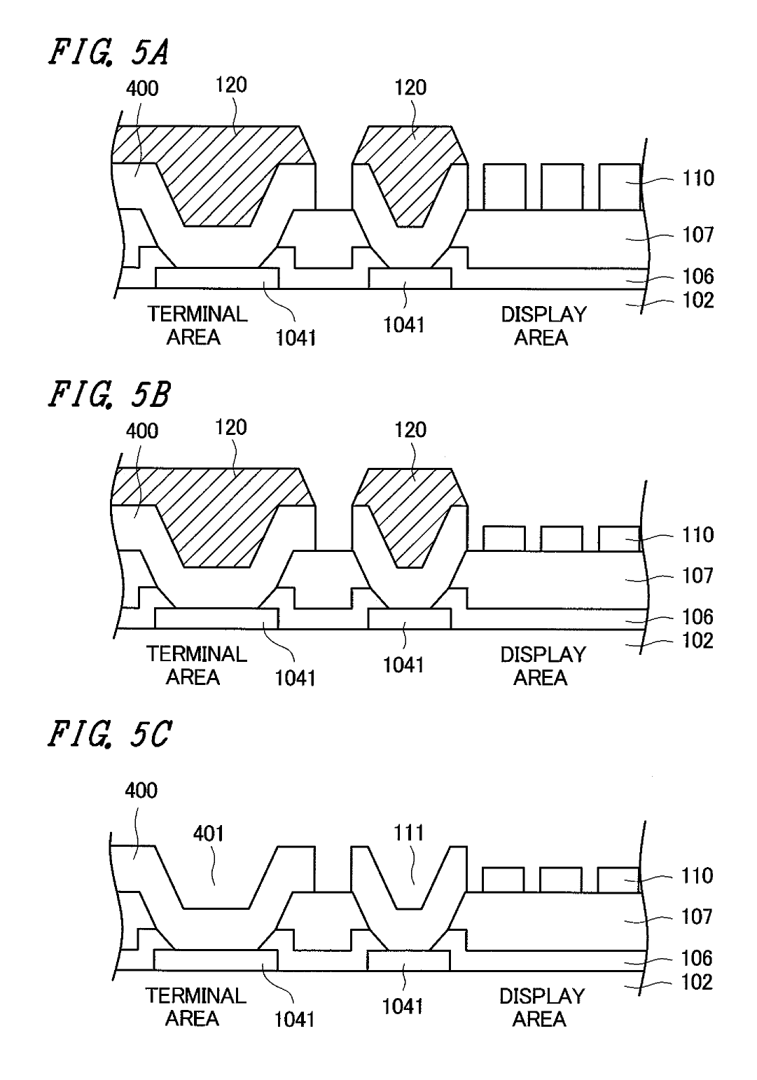

FIG. 4A to FIG. 4D and FIG. 5A to FIG. 5C show a process in which an ITO film for forming the pixel electrodes 110 is formed with a small thickness and an ITO film for forming the through holes 111 and an ITO film for forming the terminal areas 401 are formed with a large thickness without increasing the number of photolithography steps. For the sake of brevity, in respective steps shown in FIG. 4A to FIG. 5C, the cross-sectional structure of the TFT substrate 1 is omitted. That is, in FIG. 4A to FIG. 5C, the constitution of the TFT on the TFT substrate 1 is omitted so that SD lines 1041 (source/drain lines, that is, lines formed on the same layer as video signal lines 600) are directly formed on the gate insulation film 102.

Further, in FIG. 4A to FIG. 5C, the pixel electrodes 110 are formed on an inorganic passivation film 106 and an organic passivation film 107. However, in an actual process, between the pixel electrodes 110 and the organic passivation film 107, planar matted counter electrode 108 is formed and an upper insulation film 109 is formed on the counter electrode 108. The pixel electrodes 110 are formed on the upper insulation film 109. FIG. 4A to FIG. 5C are schematic cross-sectional views for explaining the embodiment 1 and hence, the counter electrode 108 and the upper insulation film 109 are omitted.

In FIG. 4A, the SD lines 1041 are formed on the gate insulation film 102. The SD lines 1041 at the through holes 111 are also simultaneously formed using the same process. The inorganic passivation film 106 and the organic passivation film 107 are formed in a state that these passivation films 106, 107 cover the SD lines 1041. At the terminal areas 401 and the through hole portions 111, a through hole 111 is formed in the inorganic passivation film 106 and the organic passivation film 107.

In FIG. 4B, an ITO film is applied to the TFT substrate 1 such that the ITO film covers the terminal area 401 and the through hole portions 111. The ITO film has a film thickness of 77 μm, for example. By setting the film thickness of the ITO film to approximately 77 μm, the ITO film sufficiently plays a role of a protective film at the terminal areas 401. Further, there is no possibility that a broken step is formed at the though hole portion 111.

In FIG. 4C, a photo resist 120 is formed on the ITO film for patterning the ITO film. In forming the photo resist 120, the photo resist 120 is applied to the ITO film by coating, and the photo resist 120 is exposed and developed using a mask such that the photo resist 120 is formed into a predetermined pattern. A positive photo resist is used as the photo resist 120 and hence, portions of the photo resist which receive light react with light and become soluble with a developer.

In the present invention, a half exposure technique is used in exposing the photo resist 120. That is, in the exposure of the photo resist 120 at the through hole portions 111 and at the terminal areas 401, a stripe-shaped or dot-shaped pattern is formed on the mask so as to decrease an exposure amount to the photo resist 120 at these portions 111, 401 compared to the an exposure amount to the photo resist 120 at the pixel-electrode-110 portions. When an exposure amount is small, a photo reaction of the photo resist 120 does not progress sufficiently and hence, when the photo resist 120 is developed, a film thickness of a half exposure portion of the photo resist 120 becomes large.

FIG. 4D shows the cross-sectional structure obtained, as shown in FIG. 4C, by etching the ITO film on which the photo resist 120 is formed thus patterning the ITO film. Irrelevant to the film thickness of the photo resist 120 formed on the ITO film, the ITO film is etched.

Thereafter, etching-back (half ashing) is applied to the photo resist 120 using an oxygen asher with respect to the TFT substrate 1 in a state shown in FIG. 4D. Then, as shown in FIG. 5A, etching-back is performed until the photo resist 120 formed on the ITO film is eliminated at the pixel-electrode-110 portions. Here, the thickness of the photo resist 120 formed at the through holes 111 and the terminal area 401 is large and hence, all the photo resist 120 is not etched back and remains at the through holes 111 and the terminal area 401.

Thereafter, light etching is applied to the ITO film in a state shown in FIG. 5A using a buffered hydrofluoric acid solution thus decreasing a thickness of the ITO film in the display area. The state where the thickness of the ITO film is decreased is shown in FIG. 5B. The ITO film can obtain a predetermined film thickness by accurately controlling an etching time. The film thickness of the ITO film at the display area may be set to approximately 50 nm, 30 nm or 10 nm, for example. The ITO film at the display area is not provided for allowing an electric current to pass therethrough but for applying an electric field to the liquid crystal layer and hence, there is no problem in increasing the resistance of the ITO film at the display area. Accordingly, it is sufficient to set the film thickness of the ITO film at the display area to approximately 30 nm which is a half or less of the film thickness of the ITO film at the through hole portion 111 or the terminal area 401. Further, when an etching control is possible, the film thickness of the ITO film may be set to approximately 20 nm.

By performing the light etching of the ITO film in FIG. 55 and by removing the photo resist 120 thereafter, it is possible to provide the constitution where the ITO film at the display area has a film thickness smaller than a film thickness of the ITO film at the through hole portion 111 or at the terminal area 401 as shown in FIG. 5C.

After forming the ITO films which differ in film thickness as shown in FIG. 5C, the alignment film 113 is applied to the organic passivation film 107 and the alignment film 113 is baked. Thereafter, rubbing is applied to the alignment film 113 thus completing the TFT substrate 1. As shown in FIG. 5C, the film thickness of the ITO film at the display area is small, a depth between the comb-teeth-shaped electrodes is small and hence, fiber 150 of a rubbing cloth can intrude into the gap defined between the comb-teeth-shaped electrodes so that the alignment film 113 disposed between the comb-teeth-shaped electrodes is also rubbed. In this manner, according to the present invention, it is possible to obtain a liquid crystal display device which can display an excellent image free from image retention phenomenon.

In the explanation made heretofore, the explanation has been made with respect to the IPS liquid crystal display device where the counter electrode 108 is formed of a planar matted film and the comb-teeth-shaped pixel electrode 110 is arranged on the counter electrode 108 by way of upper electrode. However, the present invention is also applicable to a liquid crystal display device having the opposite constitution where the pixel electrode 110 is formed of a planar matted film and the comb-teeth-shaped counter electrode 108 is arranged on the pixel electrode 110 by way of an insulation film.

Further, different from the above-mentioned IPS electrode structure explained heretofore, the present invention is also applicable to the IPS electrode structure where the comb-teeth-shaped pixel electrode 110 is arranged on the comb-teeth-shaped counter electrode 108 by way of the insulation film.

What is claimed is:

1. A liquid crystal display device having a liquid crystal display panel, the liquid crystal display panel comprising:
a TFT substrate where pixels each of which includes a comb-teeth-shaped first electrode, a planar second electrode and a TFT are formed in a matrix array so as to form a display region, and a terminal area which includes terminal electrodes is formed outside the display region;
a counter substrate on which color filters are formed; and
a liquid crystal layer which is sandwiched between the TFT substrate and the counter substrate, wherein
the first electrode is arranged above the second electrode with an insulation film sandwiched therebetween,
the first electrode and the second electrode are formed of an ITO film, the first electrode is connected with the TFT via the ITO film formed in a through hole, and the terminal electrodes are formed of the ITO film, and
a thickness of the ITO film for forming the first electrode is smaller than a thickness of the ITO film formed in the through hole and a thickness of the ITO film formed on the terminal area.

2. A liquid crystal display device according to claim 1, wherein the first electrode is a pixel electrode, and the second electrode is a counter electrode.

3. A liquid crystal display device according to claim 1, wherein the first electrode is a counter electrode, and the second electrode is a pixel electrode.

4. A liquid crystal display device according to claim 1, wherein a thickness of the ITO film for forming the first electrode is half or less of a thickness of the ITO film formed in the through hole and also is half or less of a thickness of the ITO film which constitutes the terminal electrodes.

5. A liquid crystal display device having a liquid crystal display panel, the liquid crystal display panel comprising:
a TFT substrate where pixels each of which includes a comb-teeth-shaped pixel electrode and a TFT are formed in a matrix array so as to form a display region, and a terminal area which includes terminal electrodes is formed outside the display region;
a counter substrate on which color filters are formed; and
a liquid crystal layer which is sandwiched between the TFT substrate and the counter substrate, wherein
the pixel electrode is formed of an ITO film, the first electrode is connected with the TFT via the ITO film formed in a through hole, and the terminal electrodes are formed of the ITO film, and
a thickness of the ITO film for forming the pixel electrode is smaller than a thickness of the ITO film formed in the through hole and a thickness of the ITO film formed on the terminal area.

6. A liquid crystal display device according to claim 5, wherein a thickness of the ITO film for forming the pixel electrode is half or less of a thickness of the ITO film formed in the through hole and also is half or less of a thickness of the ITO film which constitutes the terminal electrodes.

7. A manufacturing method of a liquid crystal display device having a liquid crystal display panel, the liquid crystal display panel comprising:
a TFT substrate where pixels each of which includes a comb-teeth-shaped first electrode, a planar second electrode and a TFT are formed in a matrix array so as to form a display region, and the first electrode being arranged above the second electrode with an insulation film sandwiched therebetween, the first electrode being formed of an ITO film and the first electrode and the TFT being connected with each other via an ITO film formed in a through hole, and a terminal area which includes terminal electrodes formed of an ITO film is formed outside the display region;
a counter substrate on which color filters are formed; and
a liquid crystal layer which is sandwiched between the TFT substrate and the counter substrate, the manufacturing method of a liquid crystal display device comprising the steps of:
simultaneously forming the ITO film for forming the first electrodes, the ITO film formed at the through holes and the ITO film for forming the terminal electrodes;
applying half exposure to portions of a photo resist corresponding to the pixel electrodes in performing patterning by applying the photo resist on the ITO films which are formed simultaneously and by exposing the photo resist;
developing the photo resist and etching the ITO film using the photo resist;
etching back the photo resist so as to remove the photo resist formed on the pixel electrodes and leaving the photo resist formed at the through holes and at the terminal electrodes, etching the pixel electrodes so as to make the ITO film for forming the pixel electrodes small; and
removing the photo resist formed at the through holes and at the terminal electrodes.

8. A manufacturing method of a liquid crystal display device according to claim 7, wherein the photo resist is etched back by an oxygen asher.
